(19) United States
(12) Patent Application Publication
(10) Pub. No.: US 2007/0287308 A1
(43) Pub. Date: Dec. 13, 2007

(54) Electrical connector

(75) Inventor: Fu-Pin Hsieh, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/810,637

(22) Filed: Jun. 6, 2007

(30) Foreign Application Priority Data
Jun. 7, 2006 (TW) 200620073499.X

(51) Int. Cl. H01R 13/44

(52) U.S. Cl. 439/140

(57) ABSTRACT

An electrical connector (1) includes a dielectric housing (11) defining some receiving holes (110), a plurality of terminals resided in the dielectric housing (11) and some locating posts (12) received in the receiving holes (110) of the dielectric housing (11). The side walls of the locating posts 12 define some dimples (1221) and the surfaces of the receiving holes 110 have some leading slots (1101) for leading the dimples (1221) and the surfaces of the leading slots (1101) define some blocking slots (1102) for blocking the dimples (1221). The locating posts (12) are embedded in the receiving holes (110) along the leading slots (1101), and the locating posts 12 are rotated till that the dimples (1221) are resided in the blocking slots (1102), thereby, the position of the locating posts (12) relative to the IC package is assured.

### BACKGROUND OF THE INVENTION

1. Field of the Invention

The present invention relates to an electrical connector, and more particularly to an electrical connector for attaching a central processing unit (CPU) to a printed circuit board (PCB).

2. General Background

Nowdays, electrical connectors are widely used in various electronic devices. The conventional electrical connector generally comprises a dielectric housing defining a plurality of receiving holes in the corner, a plurality of contacts received in the housing and some locating posts residing in the receiving holes of the dielectric housing.

In assembly, the dielectric housing is connected with the PCB via the contacts, the locating posts embed in the receiving holes of the dielectric housing by interferential engagement and partially overtop the surface of the dielectric housing. The CPU is disposed on the dielectric housing along the locating posts to achieve the electrical connection between the CPU and the PCB.

However, there are some inadequacies in the electrical connector: the dielectric housing will be heated and the receiving holes will expand when the electrical connector is soldered onto the PCB. When the diameter of the receiving holes expands to be bigger than the diameter of the locating posts, the interferential engagement is lose between the receiving holes and the locating posts so that the locating posts separates from the dielectric housing.

In view of the above, a new electrical connector which overcomes the above-mentioned disadvantages is desired.

### SUMMARY

Accordingly, an object of the present invention is to provide an electrical connector, in which the locating posts can be confined in the receiving holes firmly, thereby ensuring reliable mechanical performance of the electrical connector.

According to a preferred embodiment of the invention, an electrical connector in accordance with a preferred embodiment of the present invention comprises a dielectric housing defining several receiving holes in the corner, a plurality of contacts receiving in the housing and some locating posts residing in the receiving holes of the dielectric housing. The side walls of the locating posts define several dimples and the surfaces of the receiving holes have some leading slots to guide the dimples of the locating posts. The internal surfaces of the leading slots define some blocking grooves to retain the dimples correspondingly.

The present invention has several advantages as below: the side walls of the locating posts define some dimples, and correspondingly, the surfaces of the receiving holes have some leading slots to guide the dimples and the internal surfaces of the leading slots define several blocking grooves to retain the dimples correspondingly. The dimples of the locating posts are put in the receiving holes, the locating posts are rotated till the dimples of the locating posts are embedded in the blocking grooves, the locating posts are confined in the receiving holes firmly.

### BRIEF DESCRIPTION OF THE DRAWINGS

FIG. 1 is an exploded, perspective view of an electrical connector in accordance with the preferred embodiment of the present invention;

FIG. 2 is an enlarged view of a circled part A in FIG. 1.

### DETAILED DESCRIPTION OF THE PREFERRED EMBODIMENT OF THE INVENTION

Reference will now be made to the drawings to describe the present invention in detail.

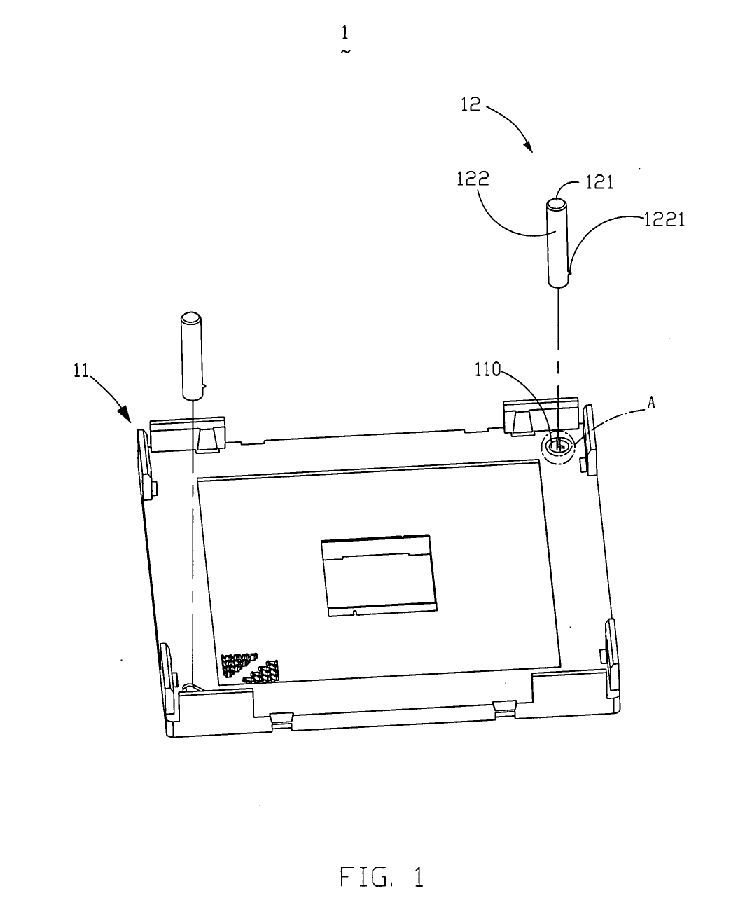

Referring to FIG. 1, an electrical connector 1 for attaching a CPU (not shown) to a PCB comprises a dielectric housing 11 defining several receiving holes 110 at corners, a plurality of contacts embedded in the dielectric housing 11, and some locating posts 12 assembled in the receiving holes 110.

The locating post 12 is made of metal material and has a column configuration. Each of the locating posts 12 defines a bottom surface 121 and a side surface 122, and the side surface 122 defines a plurality of dimples 1221. The locating posts 12 partially overtop the surface of the dielectric housing 11 to guide the CPU.

The dielectric housing 11 defines at least two receiving holes 110 and at least two locating posts 12 are embedded in the receiving holes 110 correspondingly. A diameter of the locating post 12 is substantially equal to that of the receiving hole 110. In fact, the diameters of the locating post 12 and the receiving hole 110 may be different according to the actual requests.

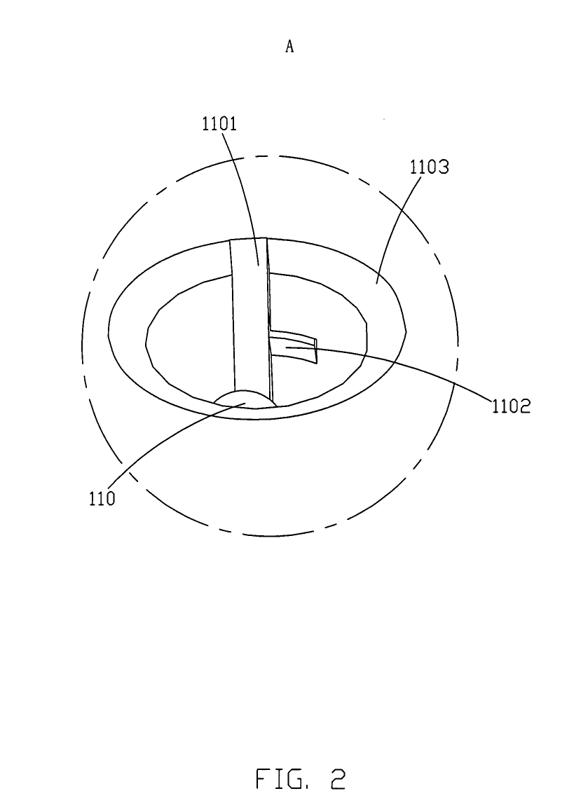

Referring to FIG. 2, an internal surface of the receiving holes 110 defines a plurality of leading slots 1101 to lead the dimples 1221 of the locating posts 12, and the leading slots 1101 have several blocking grooves 1102 to retain the dimples 1221 of the locating posts 12. The leading slots 1101 is open to the blocking groove 1102. The sizes of the leading slots 1101 and the blocking grooves 1102 are suited to the sizes of the dimples 1221 of the locating posts 12. The top of the receiving holes 110 define an inclined surface 1103 to guide the locating posts 12.

In assembly, the locating posts 12 are embedded in the receiving holes 110 of the dielectric housing 11 along the leading slots 1101. The locating posts 12 are rotated till the dimples 1221 of the locating posts 12 are embedded in the blocking grooves 1102 to achieve that the locating posts 12 are confined in the dielectric housing 11 firmly, the CPU is situated on the dielectric housing 11 along the locating posts 12 to connect with the PCB via the contacts.

While preferred embodiment in accordance with the present invention has been shown and described, equivalent modifications and changes known to persons skilled in the art according to the spirit of the present invention are considered within the scope of the present invention as defined in the appended claims.

What is claimed is:

1. An electrical connector comprising:
a dielectric housing defining a plurality of receiving holes in respective corners;
a plurality of contacts received in the dielectric housing;
a plurality of locating posts assembled in the receiving holes of the dielectric housing;
wherein a surface of the locating post defines a plurality of dimples, and an internal surface of the receiving hole defines a plurality of leading slots for guiding the dimples, and the leading slot defines a blocking groove for retaining the dimple, the leading slot being communicated with the leading slots.

2. The electrical connector as claimed in claim 1, wherein the locating posts are situated in the corners of the dielectric housing.

3. The electrical connector as claimed in claim 1, wherein at least two locating posts are defined on the cross situated in the dielectric housing.

4. The electrical connector as claimed in claim 3, wherein the diameters of the locating posts are different.

5. The electrical connector as claimed in claim 1, wherein a top of the receiving hole defines an inclined surface for guiding the locating posts.

6. An electrical connector comprising:
a dielectric housing defining at least one receiving hole around one corner, said at least one receiving hole defining an inner surface;
a plurality of contacts disposed in the housing;
at least one locating post assembled into the at least one receiving hole and defining an outer surface;
one of said inner surface and said outer surface forming a dimple thereon, the other defining a vertical leading slot and a transverse blocking groove communicating with said leading slot so as to guide insertion of the locating post into the receiving hole under a condition that the dimple initially moves along the leading slot by linear movement and successively along the blocking groove by rotative movement.

7. The electrical connector as claimed in claim 6, wherein the dimple is formed on the outer surface of the locating post, and the leading slot and the blocking groove is formed in the inner surface of the receiving hole.
